(19) United States
(12) Patent Application Publication
(10) Pub. No.: US 2020/0104542 A1
(43) Pub. Date: Apr. 2, 2020

(54) SIMULATION RESULTS EVALUATION DEVICE AND METHOD

(71) Applicant: MITSUBISHI HITACHI POWER SYSTEMS, LTD., Yokohama-shi, Kanagawa (JP)

(72) Inventors: Kazutaka Obara, Yokohama-shi (JP); Yoshinori Yamasaki, Yokohama-shi (JP); Kazuhiro Domoto, Yokohama-shi (JP); Arun Kumar Chaurasia, Yokohama-shi (JP); Hisashi Sanda, Yokohama-shi (JP); Hirotomo Hirahara, Yokohama-shi (JP); Atsushi Miyata, Yokohama-shi (JP); Keigo Matsumoto, Tokyo (JP); Hiroyoshi Kubo, Tokyo (JP); Toshihiro Baba, Yokohama-shi (JP)

(73) Assignee: MITSUBISHI HITACHI POWER SYSTEMS, LTD., Yokohama-shi, Kanagawa (JP)

(21) Appl. No.: 16/484,773

(22) PCT Filed: Feb. 5, 2018
(86) PCT No.: PCT/JP2018/003866

§ 371 Date: Aug. 8, 2019

(30) Foreign Application Priority Data
Feb. 10, 2017 (JP) 2017-023580

(51) Int. Cl. G06F 30/20; H02J 3/00

(52) U.S. Cl. CPC G06F 30/20; G06F 2119/02; H02J 3/004

(57) ABSTRACT

A simulation results evaluation device applies plural numbers of virtual input parameters (VIPs) of a simulation test of the power generation facility to model data showing virtual behaviors of the power generation facility. The device calculates each of virtual process values (VPVs) with respect to each of the VIPs and a score obtained by multiplying the VPV by a coefficient of a positive value when the VPV is included in a predetermined target range, the coefficient being set for each of the VPVs, the coefficient being assigned such that as a deviation from a predetermined target becomes greater, the value of the coefficient becomes smaller, or a coefficient of a negative value when the VPV is included within a permissible range provided adjacently to the predetermined target range. The device extracts a simulation test condition that satisfies a predetermined evaluation condition based on the calculated score.

### TECHNICAL FIELD

The present invention relates to a device and method for evaluating results of a simulation executed on operation behaviors of a power generation facility and the like for example.

### BACKGROUND ART

In operating a boiler installed in a thermal power generation plant, it is required to adjust the input parameter showing the operation condition which is, for example, the operation condition in a boiler furnace with respect to each burner that combusts input fuel with an oxidizing agent (the air). That is to say, the input parameters are operated employing the opening of the damper adjusting the flow rate of the combustion air and the burner nozzle angle in each burner and the classification rotation speed of a grinding machine for a solid fuel such as the coal as the input items, and various process values, namely the generation amount of NOx and CO and the metal temperature of each heat-transfer tube for example, are obtained as an output of the result of the operation of the boiler according to the input parameters. In adjusting combustion of a boiler, there are a lot of input items of several tens items or more, the relation between the parameter of the input item and the process value is obtained as a result of a complicated mutual relation, therefore an engineer adjusts the operation condition while properly adjusting the input parameters and the order of priority of the input items based on an empirical value and a degree of proficiency of the individual so that the various process values fall within a proper range, however, it takes a long time for adjusting combustion of a boiler, and there is a demand of trying the operation conditions of a lot of number of times changing the input parameters while monitoring the change of the process values in order to search for a more excellent operation condition.

However, when a boiler is actually operated and a test operation is executed using the operation conditions of a lot of number of times, the test operation time inevitably becomes long, and therefore there is a restriction on the number of the patterns of the operation condition with which the test operation can be executed. Therefore, it is also conceivable to virtually execute greater numbers of the operation conditions within a shorter time by an operation simulation compared to a case of confirmation of the process values with respect to the actual input parameters by a test operation, however, at that time, it becomes important to properly evaluate the simulation results of a lot of number of times. With respect to this point, in Patent Literature 1, there are described that the reference model output is made a weighted sum of plural numbers of the model output, and that the evaluation function value for a parameter is made a larger value as the reference model output is smaller (for example, refer to the paragraphs 0064-0067, FIG. 3, and Claim 8 of Patent Literature 1).

### CITATION LIST

### Patent Literature

PATENT LITERATURE 1: Japanese Patent No. 4627553

### SUMMARY OF INVENTION

### Technical Problem

In the operation simulation, when the number of patterns of the test condition becomes large, comparison between many simulation results is required, and therefore such consideration of facilitating an engineer to grasp the evaluation results of the simulation is required. On the other hand, with respect to the process value obtained by operation of a boiler, there are mixed the process values having different characteristics such as one having an upper limit and one having a lower limit. Therefore, as a result of an evaluation of deriving a sum obtained by simply weighting respective model outputs irrespective of the characteristics of the process value as done in Patent Literature 1, the evaluation comes to be based on the magnitude of the sum derived from each parameter (the test condition of the simulation), and there remains a problem that an engineer hardly grasps the simulation results of the test condition intuitively.

The present invention has been achieved in view of the circumstances described above, and its object is to provide a technology capable of efficiently and accurately executing comparison and evaluation of simulation results using test conditions of plural numbers of operation simulations.

### Solution to Problem

In order to solve the problem described above, a simulation results evaluation device of a thermal power generation facility related to the present invention is a simulation results evaluation device of a thermal power generation facility, the simulation results evaluation device including a model data storage section to store model data that show a virtual behavior of the thermal power generation facility, an input section to receive inputting of plural numbers of virtual input parameters used as a simulation test condition of the thermal power generation facility, a simulation section to read the model data from the model data storage section, to apply the virtual input parameters to the model data, and to calculate each of virtual process values with respect to each of the virtual input parameters, a test result storage section to store test result data that relate a virtual process value obtained by the simulation test to a virtual input parameter used in the simulation test, a score calculation section to calculate a score obtained by multiplying the virtual process value by a coefficient of a positive value when the virtual process value is included in a predetermined target range, the coefficient being set for each of the virtual process values, the coefficient being assigned such that as a deviation from a predetermined target becomes greater, the value of the coefficient becomes smaller, and to calculate a score obtained by multiplying the virtual process value by the coefficient of a negative value when the virtual process value is included within an allowable range provided adjacent to the predetermined target range, and an evaluation section to extract a simulation test condition that satisfies a predetermined evaluation condition based on the calculated score.

According to the invention described above, because the simulation test results are evaluated after converting the virtual process value to a score, even when a different kind of the virtual process value with a different unit may be mixed, evaluation using all virtual process values can be executed without being affected by the difference of the unit, and accuracy is enhanced.

Also, because a score of a virtual process value within the predetermined target range becomes a positive value and a score of a virtual process value within the allowable range becomes a negative value, whether a virtual process value is within a target range can be evaluated only by looking at the sign of the score of the test result.

Further, when evaluation is executed for each of the test conditions based on a score of a virtual process value included in the test condition of each simulation, a score value of each of the test conditions becomes a negative value as the number of the virtual process values within the allowable range is greater than that within the target range, whereas a score value of each of the test conditions becomes a positive greater value as the number of the virtual process values within the target range is greater than that within the allowable range, therefore those within the target range and those within the allowable range can be compared easily and whether the test condition is good can be determined only by the difference of the sign in comparing the test conditions, and evaluation can be executed intuitively when the test results are arrayed.

Also, an absolute value of a positive coefficient multiplied to the virtual process value included in the target range may be made smaller than an absolute value of a negative coefficient multiplied to the virtual process value included in the allowable range.

Thus, an absolute value of a score of a case the virtual process value is included in the target range becomes a smaller positive value, whereas in a simulation test of a case the virtual process value is included in the allowable range, an absolute value becomes a greater negative value. Accordingly, because the impact of the virtual process value not included in the target range on the score can be increased, comparison and determination on whether the test condition is good are made easier.

Also, the score calculation section may calculate a score obtained by multiplying the virtual process value included in a non-allowable range provided adjacent to a side different from the target range in the allowable range by a negative coefficient having an absolute value larger than an absolute value of a negative coefficient that is multiplied to the virtual process value included in the allowable range.

Thus, among the virtual process values that fall outside the target range, as a deviation from the target range is greater, the impact on the score can be increased, and therefore determination that a test condition is bad is executed easily.

Also, the evaluation section may evaluate whether a result of the simulation test is good based on at least one of a total value of the calculated scores, the minimum value of scores included in the test result data, a total value of scores calculated by multiplying a positive coefficient by a negative coefficient, or a deviation of scores included in the test result data or any combination of them.

Thus, the degree of freedom in setting the evaluation reference can be secured. For example, it is possible to execute an evaluation watching a least preferable virtual process value in a certain test, an evaluation watching a virtual process value out of the target range, and an evaluation watching whether respective virtual process values are evenly excellent.

Further, in order to solve the problem described above, the present invention is a simulation results evaluation method executed by a simulation results evaluation device, the simulation results evaluation method including the steps of applying a plurality of virtual input parameters used in a simulation test of a thermal power generation facility to model data that show virtual behaviors of the thermal power generation facility and calculating each of virtual process values with respect to each of the virtual input parameters, storing test result data that relate a virtual process value obtained by the simulation test to a virtual input parameter used in the simulation test, calculating a score obtained by multiplying the virtual process value by a coefficient of a positive value when the virtual process value is included in a predetermined target range, the coefficient being set for each of the virtual process values, the coefficient being assigned such that as a deviation from a predetermined target becomes greater, the value of the coefficient becomes smaller, and calculating a score obtained by multiplying the virtual process value by the coefficient of a negative value when the virtual process value is included within an allowable range provided adjacent to the predetermined target range, and extracting a simulation test condition that satisfies a predetermined evaluation condition based on the calculated score.

According to the invention described above, because the evaluation is executed after converting the virtual process value into a score, even when a different kind of the virtual process value with a different unit may be mixed, evaluation using all virtual process values can be executed without being affected by the difference of the unit, and accuracy is enhanced.

Also, because a score of a virtual process value within the predetermined target range becomes a positive value and a score of a virtual process value within the allowable range becomes a negative value, whether a virtual process value is within a target range can be evaluated only by looking at the sign of the score of the test result.

Further, when evaluation is executed for each of the test conditions based on a score of a virtual process value included in each test condition, a score value of each of the test conditions becomes a negative value as the number of the virtual process values within the allowable range is greater, whereas a score value of each of the test conditions becomes a positive greater value as the number of the virtual process values within the target range is greater, therefore those within the target range and those within the allowable range can be compared easily and whether the test condition is good can be determined only by the difference of the sign in comparing the test conditions, and evaluation can be executed intuitively when the test results are arrayed.

### Advantageous Effect of Invention

According to the present invention, it is possible to provide a technology capable of efficiently and accurately evaluating comparison and evaluation of simulation results using test conditions of plural numbers of operation simulations of a thermal power generation facility. Problems, configurations, and effects other than those described above will be clarified by explanation of embodiments described below.

### BRIEF DESCRIPTION OF DRAWINGS

FIG. 1 is a schematic configuration diagram that shows a boiler.

FIG. 2 is a hardware configuration diagram of a simulation results evaluation device.

FIG. 3 is a function block diagram of the simulation results evaluation device.

FIG. 4 is a flowchart that shows a flow of a process executed by the simulation results evaluation device.

FIG. 5 is a drawing that shows an example of a parameter set.

FIG. 6A is a drawing that shows an example of score conversion data (straight line) defined for a process value that aims minimization.

FIG. 6B is a drawing that shows an example of score conversion data (curved line) defined for a process value that aims minimization.

FIG. 7A is a drawing that shows an example of score conversion data (straight line) defined for a process value that aims maximization.

FIG. 7B is a drawing that shows an example of score conversion data (curved line) defined for a process value that aims maximization.

FIG. 8 is a drawing that shows an example of an output of an extraction result.

### DESCRIPTION OF EMBODIMENTS

Below, preferable embodiments related to the present invention will be explained in detail referring to the attached drawings. Also, the present invention is not limited by these embodiments. When there are plural numbers of the embodiments, the present invention also includes one configured by combination of respective embodiments. Although explanation will be given below exemplifying a boiler installed in a thermal power generation plant as a power generation facility, the power generation facility is not limited to a boiler, and other power generation facilities may be made the control objects.

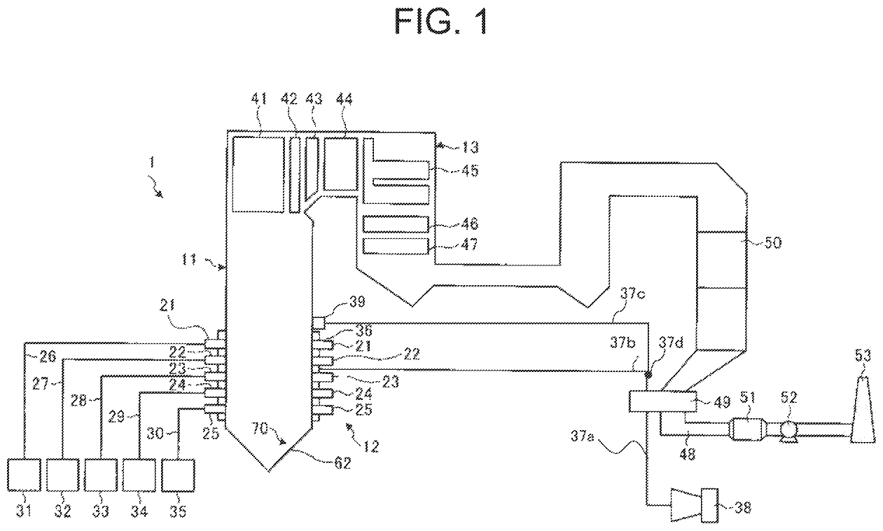

FIG. 1 is a schematic configuration diagram that shows a boiler 1.

The boiler 1 of the present embodiment is a coal-fired boiler that uses pulverized coal obtained by pulverizing coal as a pulverized fuel (solid fuel) for the purpose of combusting a solid fuel, combusts the pulverized coal by a combustion burner of a furnace, and heat-exchanges the heat generated by the combustion with the feed-water and steam to allow to generate steam.

The boiler 1 includes a furnace 11, a combustion device(s) 12, and a flue 13. The furnace 11 has a hollow shape of a rectangular tube for example, and is installed along the vertical direction. The furnace 11 is configured of evaporation tubes (heat transfer tubes) and fins connecting the evaporation tubes at the wall surface, and suppresses the temperature rise of the furnace wall by heat exchange with the feed water and steam. In concrete terms, on the side wall surface of the furnace 11, plural numbers of the evaporation tubes are disposed along the vertical direction for example, and are disposed so as to be arrayed in the horizontal direction. The fin closes the gap between an evaporation tube and an evaporation tube. The furnace 11 is provided with an inclined surface 62 at the bottom of the furnace, and is provided with a furnace bottom evaporation tube 70 on the inclined surface 62 to form the bottom surface.

The combustion device(s) 12 is (are) arranged on the lower portion side in the vertical direction of the furnace wall configuring this furnace 11. According to the present embodiment, this combustion device(s) 12 includes (include) plural numbers of combustion burners (21, 22, 23, 24, 25 for example) attached to the furnace wall. For example, these combustion burners (burners) 21, 22, 23, 24, 25 are disposed by plural numbers at equal intervals along the peripheral direction of the furnace 11. However, the shape of the furnace, the number of pieces of the combustion burner in one stage, and the number of stages are not limited to this embodiment.

Each of these combustion burners 21, 22, 23, 24, 25 is connected to a grinding machine (pulverizer or mill) 31, 32, 33, 34, 35 through a pulverized coal pipe 26, 27, 28, 29, 30. When the coal is transported by a transportation system not illustrated and is fed to the grinding machine 31, 32, 33, 34, 35, the coal is ground here to a predetermined powder size, and the ground coal (pulverized coal) can be supplied from the pulverized coal pipe 26, 27, 28, 29, 30 to the combustion burner 21, 22, 23, 24, 25 along with the transportation air (primary air).

Also, with respect to the furnace 11, a wind box 36 is arranged at the attaching position of the respective combustion burners 21, 22, 23, 24, 25, one end of an air duct 37b is connected to this wind box 36, and the other end is connected to an air duct 37a at a connection point 37d, the air duct 37a supplying the air.

Also, the flue 13 is connected to the upper part in the vertical direction of the furnace 11, and plural numbers of heat exchangers (41, 42, 43, 44, 45, 46, 47) for generating steam are disposed in the flue 13. Therefore, the combustion burners 21, 22, 23, 24, 25 inject a gas mixture of the pulverized coal fuel and the combustion air into the furnace 11, thereby flames are formed, and the combustion gas is formed and flows through the flue 13. Also, the feed water and the steam flowing along the furnace wall and the heat exchangers (41-47) are heated by the combustion gas to generate superheated steam, and the generated superheated steam is supplied to and rotationally drives a steam turbine not illustrated, rotationally drives a power generator not illustrated connected to a rotary shaft of the steam turbine, and can generate power. Further, with respect to the flue 13, an exhaust gas duct 48 is connected, a Selective Catalytic NOx Reduction system 50, an air heater 49, an electric dust precipitator 51, an induced draft fan 52, and the like are arranged, the denitrification Selective Catalytic NOx Reduction system 50 being for purification of the combustion gas, the air heater 49 executing heat exchange between the air and the exhaust gas, the air being fed from a forced draft fan 38 to the air duct 37a, the exhaust gas being fed to the exhaust gas duct 48, and a stack 53 is arranged at the downstream end.

The furnace 11 of the present embodiment is a so-called 2-stage combustion type furnace that executes fuel-excess combustion of the pulverized coal by the transportation air (primary air) and the combustion air (secondary air), the combustion air being fed from the wind box 36 to the furnace 11, and thereafter newly feeds combustion air (additional air) to execute fuel-lean combustion. Therefore, the furnace 11 is provided with an additional air port 39, one end of an air duct 37c is connected to the additional air port 39, and the other end is connected to the air duct 37a at the connection point 37d, the air duct 37a supplying the air.

The air fed from the forced draft fan 38 to the air duct 38a is heated by the air heater 49 by heat exchange with the combustion gas at the air heater 49, and is divided into a secondary air and an after-air at the connection point 37d, the secondary air being guided to the wind box 36 through the air duct 37b, the additional air being guided to the additional air port 39 through the air duct 37c.

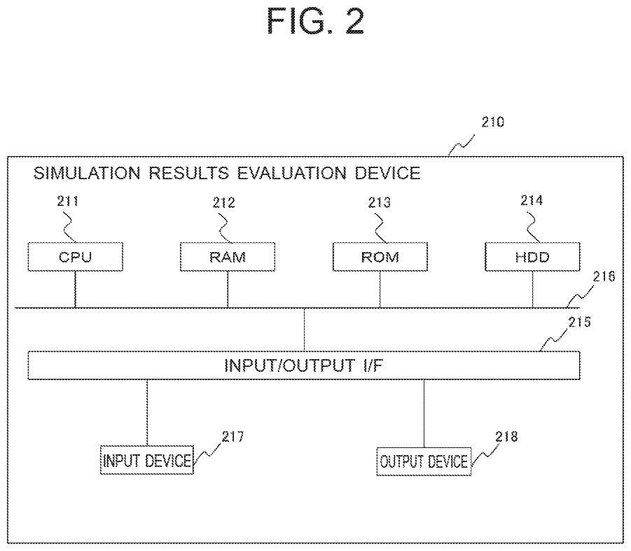

FIG. 2 is a hardware configuration diagram of a simulation results evaluation device 210 that simulates virtual operation behaviors of the boiler 1 and evaluates the results of the simulation. The simulation results evaluation device 210 is configured that a CPU (Central Processing Unit) 211, a RAM (Random Access Memory) 212, a ROM (Read Only Memory) 213, an HDD (Hard Disk Drive) 214, and an input/output interface (I/F) 215 are included and that they are connected to each other through a bus 216. To the input/output interface (I/F) 215, an input device 217 such as a keyboard and an output device 218 such as a display and a printer are connected respectively. Also, the hardware configuration of the simulation results evaluation device 210 is not limited to the above, and may be configured by a combination of a control circuit and a storage device.

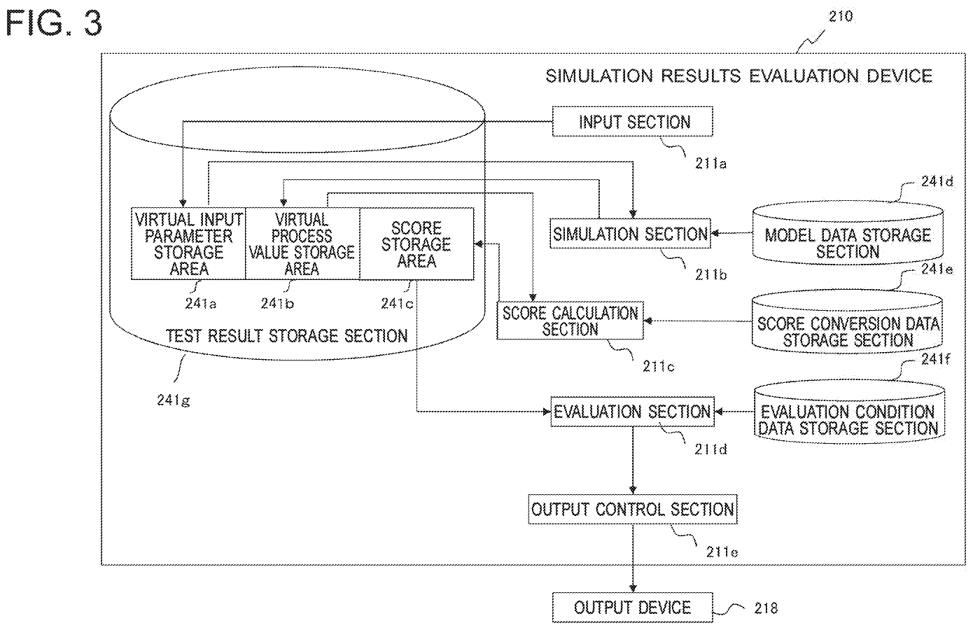

FIG. 3 is a function block diagram of the simulation results evaluation device 210. The simulation results evaluation device 210 includes an input section 211a, a simulation section 211b, a score calculation section 211c, an evaluation section 211d, and an output control section 211e. These constituent elements may be configured by that the CPU 211 reads software, loads the software on the RAM 212, and executes the software, and thereby the software and the hardware work jointly, the software achieving respective functions stored beforehand in the ROM 213 and the HDD 214, or may be configured by a control circuit that achieves the respective functions. Also, the simulation results evaluation device 210 includes a test result storage section 241g, a model data storage section 241d, a score conversion data storage section 241e, and an evaluation condition data storage section 241f, the test result storage section 241g including a virtual input parameter storage area 241a, a virtual process value storage area 241b, and a score storage area 241c, and relating and storing the virtual input parameter, the virtual process value, and the score. They may be configured in a partial region of the storage device such as the RAM 212, the ROM 213, and the HDD 214.

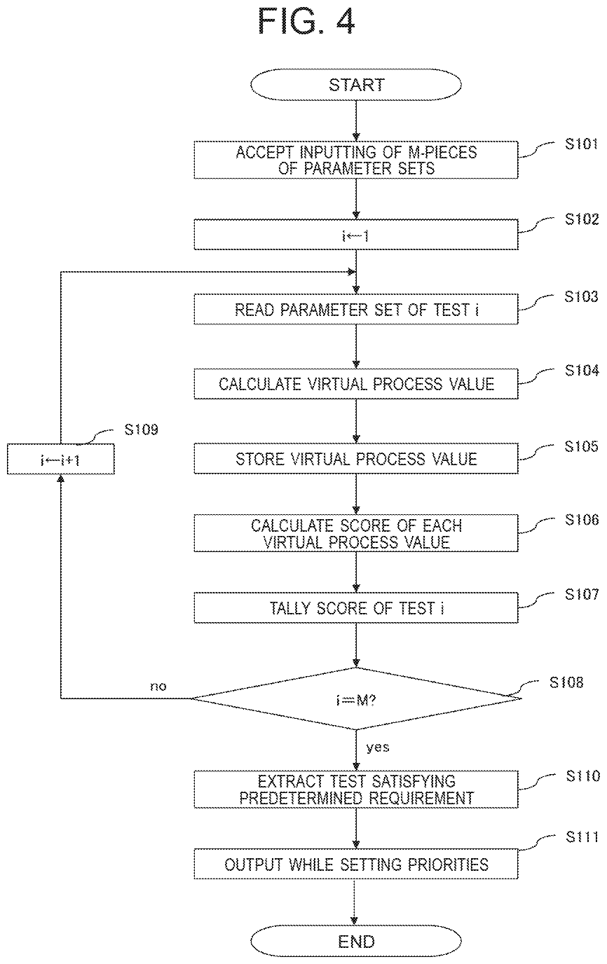

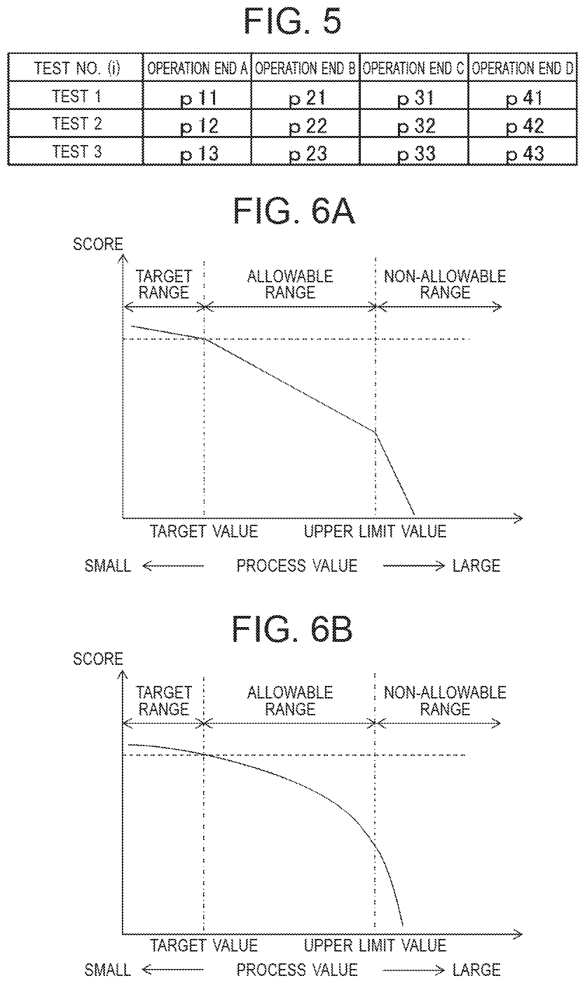

The processing content executed by the simulation results evaluation device 210 will be explained referring to FIG. 4 and FIG. 5. FIG. 4 is a flowchart that shows a flow of a process executed by the simulation results evaluation device 210. FIG. 5 is a drawing that shows an example of a parameter set.

First, the input section 211a accepts an input of the virtual parameter used for the simulation test (will be hereinafter abbreviated as “test”) (S101). Plural numbers of the virtual parameters used for one test will be hereinafter collectively referred to as a “parameter set”. As the virtual input parameter, the supply flow rate of the combustion air (secondary air), the burner nozzle angle, the number of units in operation of the fuel supply apparatus (pulverized coal fuel supply flow rate), and the after-air port opening degree (after-air supply flow rate) for example may be used. Also, as the virtual process value data, the environmental load quantity (the concentration of NOx and CO), the equipment efficiency, the temperature of the component, the temperature of the steam, the temperature of the heat-transfer metal, and the like may be used.

In an example of FIG. 5, in “Test 1”, the parameter set 1 is set, the parameter set 1 including virtual input parameters (p11, p21, p31, p41) for each of operation ends A, B, C, D. In a similar manner, (p12, p22, p32, p42) are set in Test 2, and (p13, p23, p33, p43) are set in Test 3. The simulation results evaluation device 210 accepts inputting of the parameter sets of M-pieces through the input device 217. The input section 211a allows the virtual input parameter storage area 241a to store the parameter sets, inputting of the parameter sets having been accepted.

The simulation section 211b inputs the initial value 1 to the test number i (S102), and reads the parameter set i (p1i, p2i, p3i, p4i) of the test number i (S103).

In the model data storage section 241d, model data determined according to the kind of the process value are stored by a number of piece same to the number of kinds of the process value. For example, assume that the process values of N-pieces including a process value A, a process value B, a process value C, . . . , a process value N are obtained by an actual operation of the boiler 1. In this case, in the model data storage section 241d, model data fA (x1, x2, x3, x4) used for calculation of the process value A are stored. In a similar manner, fB (x1, x2, x3, x4), fC (x1, x2, x3, x4), . . . , fN (x1, x2, x3, x4) used for calculation of the process value B, the process value C, . . . , the process value N are stored.

The simulation section 211b applies the parameter set i (p1i, p2i, p3i, p4i) to each model data, and calculates each process value of the test number i by an expression (1) below (S104).

$$\begin{matrix}[ Math . 1 ] & \\ \begin{matrix}Ai = fA ( p 1 i , p 2 i , p 3 i , p 4 i ) \\ Bi = fB ( p 1 i , p 2 i , p 3 i , p 4 i ) \\ Ci = fC ( p 1 i , p 2 i , p 3 i , p 4 i ) \\ ⋮ \\ Ni = fN ( p 1 i , p 2 i , p 3 i , p 4 i )\end{matrix} \} & ( 1 )\end{matrix}$$

The simulation section 211b stores the virtual process values Ai, Bi, Ci, . . . , Ni having been calculated in the virtual process value storage area 241b (S105).

The score calculation section 211c reads the score conversion data having been set beforehand with respect to the kind of each process value from the score conversion data storage section 241e, and calculates the score of each virtual process value of the test i stored in the virtual process value storage area 241b (S106).

Here, with respect to each virtual process value, the value of scoring is to become smaller as the deviation from the predetermined target becomes greater, and there exist the characteristics of each process value where the score increases as the process value is smaller and the score increases as the process value is greater for example. Therefore, the upper limit value and the lower limit value are set according to the characteristics of the process value.

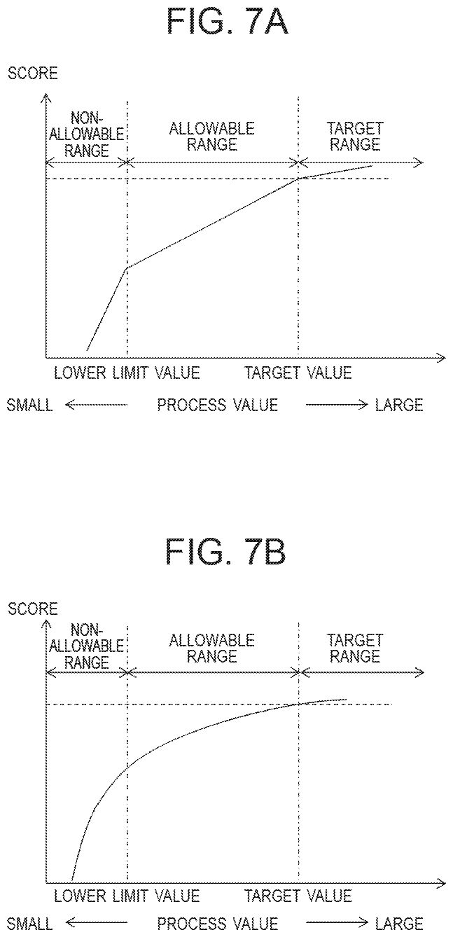

FIG. 6 and FIG. 7 are drawings that show an example of score conversion data. FIG. 6A and FIG. 6B show score conversion data defined for a process value that aims minimization, FIG. 6A shows an example where the score conversion line is defined by a straight line, and FIG. 6B shows an example where the score conversion line is defined by a curved line.

In FIG. 6A and FIG. 6B, a target value and an upper limit value having a value greater than the target value are set. A range on the smaller side of the target value is made a target range, and a coefficient having a positive value is assigned. A range from the target value to the upper limit value is made an allowable range, and a coefficient having a negative value is assigned. The score of the vertical axis of FIG. 6A and FIG. 6B becomes a positive value in the upward direction from the chain line on the paper surface, and becomes a negative value in the downward direction from the chain line on the paper surface. An absolute value of the coefficient of the allowable range is made a value greater than an absolute value of the coefficient of the target range. That is to say, an inclination of the score conversion line of the allowable range is set to be greater than an inclination of the score conversion line of the target range.

A range on the greater side of the upper limit value is made a non-allowable range, and a coefficient having a negative value with an absolute value greater than an absolute value of a coefficient of the allowable range is assigned. That is to say, an inclination of the score conversion line of the non-allowable range is set to be greater than an inclination of the score conversion line of the allowable range.

FIG. 7A and FIG. 7B show score conversion data defined for a process value that aims maximization, and a lower limit value and a target value having a value greater than the lower limit value are set. A range on the greater side of the target value is made a target range, and a coefficient having a positive value is assigned. A range from the target value to the lower limit value is made an allowable range, and a coefficient having a negative value is assigned. The score of the vertical axis of FIG. 7A and FIG. 7B becomes a positive value in the upward direction from the chain line on the paper surface, and becomes a negative value in the downward direction from the chain line on the paper surface. An absolute value of the coefficient of the allowable range is made a value greater than an absolute value of the coefficient of the target range. That is to say, an inclination of the score conversion line of the allowable range is set to be greater than an inclination of the score conversion line of the target range.

A range on the smaller side of the lower limit value is made a non-allowable range, and a coefficient having a negative value with an absolute value greater than an absolute value of a coefficient of the allowable range is assigned. That is to say, an inclination of the score conversion line of the non-allowable range is set to be greater than an inclination of the score conversion line of the allowable range.

With respect to each virtual process value, the score calculation section 211c calculates, for example, a score of each virtual process value using an expression (2) below for one where a target value and an upper limit value having a value greater than the target value are set as done in FIG. 6A and FIG. 6B, and using an expression (3) below for one where a lower limit value and a target value having a value greater than the lower limit value are set as done in FIG. 7A and FIG. 7B (S106).

SAi=CAi×(upper limit value−virtual process value) (2)

SAi=CAi×(virtual process value−lower limit value) (3)

where
SAi: a score of the virtual process value Ai of the test number i
CAi: a coefficient assigned to the virtual process value Ai

The score calculation section 211c writes the calculated score in the score storage area 241c.

The score calculation section 211c tallies a total value of the plus scores, a total value of the minus scores, and a total value of all scores with respect to the test i, and writes the results in the score storage area 241c (S107).

The input section 211a determines whether the test number i is a number same to the number of pieces M of the parameter set having been read in the step S101. If no (S108/no), the input section 211a increments i (S109), and reads the parameter set of the next test number i+1 (S103).

When the test number i is a number same to the number of pieces M of the parameter set having been read in the step S101 (S108/yes), the evaluation section 211d reads the evaluation condition from the evaluation condition data storage section 241f, refers to the scores of all tests stored in the score storage area 241c, extracts parameter sets of tests having satisfied a predetermined requirement (S110), sets priorities of and outputs the parameter sets under an evaluation condition described below (S111). Also, when each score can be determined upon looking at an output list such as a case the number of pieces M of the parameter sets is small and the test number is not high, the parameter sets may be outputted without setting priorities. Further, the method of setting priorities may be different according to the evaluation condition.

With respect to the evaluation condition, one condition may be used, namely a condition of selecting at least one or more test in the order of higher total score for example, or plural conditions may be combined and used. Examples of the evaluation condition are shown below.

First condition: a test with the highest point in the total score
Second condition: a test where the total value of the minus scores is the maximum (the absolute value of the minus total value is the minimum), or a test where a process value becoming a minus score does not exist
Third condition: a test where the deviation of the scores included in one test is smallest

As other conditions, it is possible to use a test where the total value of the minus scores has a value greater than a predetermined minus value (the absolute value of the minus total value is a value smaller than an absolute value of a predetermined minus value), or an event that the minimum value of the scores in each test results data is largest (an absolute value is smallest when the minimum value of the scores is a minus score).

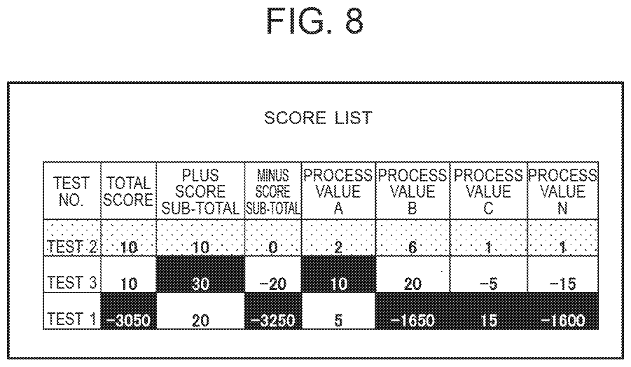

The evaluation section 211d extracts a test satisfying a predetermined condition (S110), and the output control section 211e outputs the test to the output device 218 with priorities being set (S111). FIG. 8 is a drawing that shows an example of an output of the extraction result.

In FIG. 8, the output control section 211e forms a score list and displays the score list on a display and the like, the score list arraying scores of respective tests extracted by the evaluation section 211d. At that time, with respect to a test whose evaluation is highest for example, the output control section 211e displays the score with hatching. Also, the output control section 211e reverse-displays for example the highest point and the lowest point out of the scores in each test. Further, for example, the color of the numerical value and the background may be changed, and are not to be prescribed. In the example of FIG. 8, because the total score is of a same point between the test 2 and the test 3, the evaluation section 211d determines that the both tests satisfy the first condition. Next, the evaluation section 211d refers to the sub-total of the minus scores as the second condition, and selects the test 2 as the optimum condition because the sub-total of the minus scores of the test 2 is 0 and the sub-total of the minus scores of the test 3 is −20. Further, according to the third condition also, because a deviation of the scores of the test 2 is smaller than a deviation of the scores of the test 3, the evaluation section 211d selects the test 2 as the optimum condition.

Below, actions and effects of the present embodiment will be explained. In general, in a simulation of a power generation facility where plural numbers of the input parameters affect plural numbers of the process values, when a certain virtual input parameter is changed, a virtual process value approaching a target value and a virtual process value departing from a target value are possibly generated, and therefore the simulation results were hardly evaluated.

In this regard, according to the present embodiment, in comparison and evaluation of the simulation results using the test conditions of plural numbers of the operation simulations, the score conversion data according to the characteristics of the process value are prepared, respective virtual process values are calculated, and therefore a load of an engineer required for evaluation of the simulation results can be reduced.

In addition, because the virtual process values themselves are different in the unit, even when the virtual process values are compared to each other, whether a virtual process value is good is hardly determined. However, by conversion of the score according to the characteristics of each virtual process value, comparison of the virtual process values and evaluation of the test results are facilitated. Also, all of plural numbers of the process values can be reflected on evaluation, and accuracy is enhanced.

In this score conversion in particular, the target range and the allowable range are arranged according to the characteristics of the virtual process value, and an absolute value of a coefficient having a positive value used for the score calculation of the target range is made smaller than an absolute value of a coefficient having a negative value used for the score calculation of the allowable range. Thus, a virtual process value in the target range can be converted to a score having a positive value with a small absolute value, a virtual process value in the allowable range can be converted to a score having a negative value with a large absolute value, and it is possible to be configured that a virtual process value in the allowable range exerts a larger impact on the score total value and the minus score total value. Those where the test results are within the target range and those where the test results are within the allowable range can be compared easily in terms of the score, whether the test condition is good can be determined, and evaluation can be executed intuitively when the test results are arrayed.

Also, a non-allowable range is arranged adjacently to an allowable range, and an absolute value of a coefficient having a negative value used for the score calculation within the non-allowable range is made greater than an absolute value of a negative value used for the score calculation within the allowable range. Thus, with respect to a test result where a virtual process value included within the non-allowable range is included even by one piece, the values of the score total value and the minus score total value become smaller (an absolute value of the negative value becomes larger), and evaluation as the entirety of the test in question can be degraded. Therefore, determination that the test condition is bad can be made easily.

Based on the above, by adding a small plus point to a score of the test result when the virtual process value attains the target value, by reducing a score of the test result when the virtual process value does not attain the target range but is within the allowable range, and by reducing largely when the virtual process value exceeds the allowable range, more preferable test condition can be extracted based on a thought of attaining the target value (avoiding large reduction) in all of the virtual process values.

The embodiment described above does not limit the present invention, and various modified aspects not deviating from the gist of the present invention are included in the present embodiment. For example, the simulation may use not only a mathematical model but also a computer simulation and a neural network of the fluid analysis and the like.

Further, although at least one or more test conditions satisfying a predetermined requirement were extracted in the embodiment described above, it may be configured to extract one test condition with the highest evaluation as an optimum condition.

### REFERENCE SIGNS LIST

1 . . . Boiler
210 . . . Simulation results evaluation device
211a . . . Input section
211b . . . Simulation section
211c . . . Score calculation section
211d . . . Evaluation section
211e . . . Output control section
241a . . . Virtual input parameter storage area
241b . . . Virtual process value storage area
241c . . . Score storage area
241d . . . Model data storage section
241e . . . Score conversion data storage section
241f . . . Evaluation condition data storage section
241g . . . Test result storage section

1. A simulation results evaluation device of a thermal power generation facility, the simulation results evaluation device comprising:
a model data storage section to store model data that show a virtual behavior of the thermal power generation facility;
an input section to receive inputting of a plurality of virtual input parameters used as a simulation test condition of the thermal power generation facility;
a simulation section to read the model data from the model data storage section, to apply the virtual input parameters to the model data, and to calculate each of virtual process values with respect to each of the virtual input parameters;
a test result storage section to store test result data that relate a virtual process value obtained by the simulation test to a virtual input parameter used in the simulation test;
a score calculation section to calculate a score obtained by multiplying the virtual process value by a coefficient of a positive value when the virtual process value is included in a predetermined target range, the coefficient being set for each of the virtual process values, the coefficient being assigned such that as a deviation from a predetermined target becomes greater, the value of the coefficient becomes smaller, and to calculate a score obtained by multiplying the virtual process value by the coefficient of a negative value when the virtual process value is included within an allowable range provided adjacent to the predetermined target range; and
an evaluation section to extract a simulation test condition that satisfies a predetermined evaluation condition based on the calculated score.

2. The simulation results evaluation device according to claim 1, wherein an absolute value of a positive coefficient multiplied to the virtual process value included in the target range is smaller than an absolute value of a negative coefficient multiplied to the virtual process value included in the allowable range.

3. The simulation results evaluation device according to claim 1, wherein the score calculation section calculates a score obtained by multiplying the virtual process value included in a non-allowable range provided adjacent to a side different from the target range in the allowable range by a negative coefficient having an absolute value larger than an absolute value of a negative coefficient that is multiplied to the virtual process value included in the allowable range.

4. The simulation results evaluation device according to claim 1, wherein the evaluation section evaluates whether a result of the simulation test is good based on at least one of a total value of the calculated scores, the minimum value of scores included in the test result data, a total value of scores calculated by multiplying a negative coefficient, or a deviation of scores included in the test result data or any combination of them.

5. A simulation results evaluation method executed by a simulation results evaluation device, the simulation results evaluation method comprising the steps of:
applying a plurality of virtual input parameters used in a simulation test of a thermal power generation facility to model data that show virtual behaviors of the thermal power generation facility, and calculating each of virtual process values with respect to each of the virtual input parameters;
storing test result data that relate a virtual process value obtained by the simulation test to a virtual input parameter used in the simulation test;
calculating a score obtained by multiplying the virtual process value by a coefficient of a positive value when the virtual process value is included in a predetermined target range, the coefficient being set for each of the virtual process values, the coefficient being assigned such that as a deviation from a predetermined target becomes greater, the value of the coefficient becomes smaller, and calculating a score obtained by multiplying the virtual process value by the coefficient of a negative value when the virtual process value is included within an allowable range provided adjacent to the predetermined target range; and
extracting a test that satisfies a predetermined evaluation condition based on the calculated score.
